(19) United States
(12) Patent Application Publication
(10) Pub. No.: US 2004/0262874 A1
(43) Pub. Date: Dec. 30, 2004

(54) Steering knuckle sealant compressible shim

(76) Inventor: Mikel Lorente, Kalamazoo, MI (US)

Correspondence Address: DYKEMA GOSSETT PLLC, SUITE 300, 39577 WOODWARD, BLOOMFIELD HILLS, MI, 48304, US

(21) Appl. No.: 10/603,002

(22) Filed: Jun. 24, 2003

(51) Int. Cl. B62D 7/18

(52) U.S. Cl. 280/93.512

(57) ABSTRACT

According to the present invention, a steer-axle assembly includes sealant compressible shim fills a gap between an axle segment and a steering knuckle assembly that surrounds the kingpin. The sealant compressible shim has a first substantially rigid shim layer disposed about the kingpin body and in contact with the upper receiving portion of the steering knuckle assembly, a second substantially rigid shim layer disposed about the kingpin body and in contact with the axle segment, and at least one compressible shim layer between the first and second substantially rigid shim layers. The sealant compressible shim eliminates or reduces the entry of foreign matter into the interface between the kingpin and the steering knuckle assembly

### BACKGROUND OF THE INVENTION

1. Field of the Invention

This invention relates to a steer-axle assembly and in particular to an assembly utilizing a compressible shim between a steering knuckle assembly and an axle segment.

2. Discussion of Related Art

The outside end of an axle, the wheel end segment of an axle, may support a steering knuckle assembly which includes a spindle that supports the wheel. The steering knuckle assembly is controlled by a steering linkage which rotates the steering knuckle assembly relative to the axle and provides direction to the wheels. The steering knuckle assembly may be supported at the outer end of the axle by a kingpin. It will thus be appreciated that such kingpin assemblies constitute an important portion of a steer-axle assembly of the vehicle.

Conventional kingpin assemblies may include a body having a central portion supported within the axle and opposing outer portions disposed within bushings in upper and lower ends of a steering knuckle. A conventional steer-axle assembly may also include a bearing disposed around the central portion of the kingpin in a known manner, allowing the steering knuckle assembly to pivot relative to the axle.

Conventional steer-axle assemblies may also include a gap between the steering knuckle assembly and the axle to provide clearance so rotation of the steering knuckle assembly is not inhibited by contact with the axle, or may include a set of rigid spacers around the kingpin between the axle and the steering knuckle assembly to maintain the clearance between the axle and the steering knuckle. Under certain conditions debris may enter the interface between the kingpin and the steering knuckle through a gap between the axle and steering knuckle. The gap may be increased during dynamic vehicle use, or the gap may be increased during the life of the vehicle. This can lead to increased wear of the kingpin where it interfaces with the steering knuckle assembly. This may adversely affect the wear or performance of the system.

No known methods overcome the drawbacks of conventional systems with respect to foreign matter in the kingpin interface with the steering knuckle assembly. Various shim designs have been proposed to maintain clearance and to attempt to reduce wear in the kingpin interface due to other factors. For example, U.S. Pat. Nos. 5,975,547 and 4,690,418 and 5,709,399 each illustrate use of shims in a certain manner to address the wear of the kingpin which can lead to play between the axle and knuckle assembly. However, none address wear due to the entry of foreign matter into the kingpin interface with the steering knuckle assembly.

The inventor herein has recognized that there is a need for a steer-axle assembly that will minimize or eliminate the above-mentioned deficiencies.

### SUMMARY OF THE INVENTION

The present invention provides a steer-axle assembly for reducing or eliminating the entry of foreign matter into the interface between a kingpin and a steering knuckle assembly. The present invention reduces wear due to the entry of foreign matter into the interface, and maintains performance of the kingpin and steering knuckle assembly.

A steer-axle assembly in accordance with an embodiment of the present invention includes at least one sealant compressible shim, an axle segment, a kingpin, and a steering knuckle assembly. According to one embodiment, a sealant compressible shim is disposed around a kingpin in a gap between a steering knuckle assembly and a wheel end axle segment. The steer-axle assembly includes an axle segment having an end with a steering knuckle assembly rotably mounted thereon. The steering knuckle has at least one receiving portion. The kingpin includes a body segment and at least one interface segment. The body segment is fixedly coupled to the axle segment. The at least one interface segment and the at least one receiving portion of the steering knuckle are provided in a one to one relation so that each kingpin interface segment is received in a corresponding receiving portion of the steering knuckle. At least one sealant compressible shim is located adjacent an interface segment of the kingpin and fills a gap between the axle segment and steering knuckle assembly around the kingpin.

A steer-axle assembly in accordance with the present invention represents a significant improvement as compared to conventional steer-axle assemblies. These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a perspective view of a portion of a vehicle steer-axle assembly incorporating a steering knuckle sealant compressible shim;

FIG. 2 is a perspective view of an embodiment of a sealant compressible shim;

FIG. 3 is a cross sectional perspective view of a sealant compressible shim; and

FIG. 4 is a cross sectional view of a portion of a vehicle steer-axle assembly incorporating a steering knuckle sealant compressible shim.

### DETAILED DESCRIPTION OF THE PREFERRED EMBODIMENTS

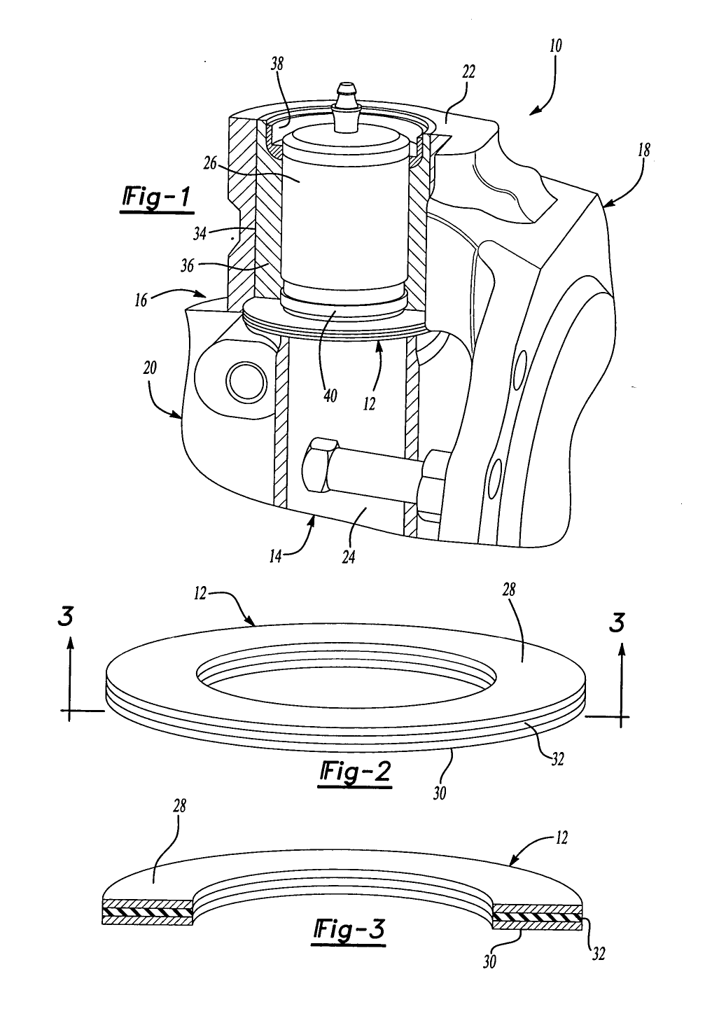

Referring now to the drawings wherein like reference numerals are used to identify identical components in the various views. FIG. 1 illustrates an embodiment of a steer-axle assembly 10 utilizing a sealant compressible shim 12 disposed about a kingpin 14 in a gap 16 between a steering knuckle assembly 18 and an axle segment 20. The steer-axle assembly 10 includes an axle segment 20 having an end with a steering knuckle assembly 18 rotably mounted thereon. The steering knuckle assembly 18 has at least one receiving portion 22. The kingpin 14 includes a body segment 24 and at least one interface segment 26. The body segment 24 is fixedly coupled to the axle segment 20 by known means. The interface segment 26 of the kingpin 14 and the receiving portion 22 of the steering knuckle assembly 18 are provided in a one to one relation so that each kingpin 14 interface segment 26 is received in a corresponding receiving portion 22 of the steering knuckle assembly 18. At least one sealant compressible shim 12 is located adjacent an interface segment 26 of the kingpin 14 and fills a gap 16 between the axle segment 20 and steering knuckle assembly 18 around the kingpin 14.

The sealant compressible shim 12 has a first substantially rigid shim layer disposed about the body segment 24 and in contact with the steering knuckle assembly 18, a second substantially rigid shim 30 layer disposed about the body segment 24 in contact with the axle segment 20, and at least one compressible shim layer 32 between the first 28 and second 30 substantially rigid shim layers.

According to one embodiment, the steering knuckle assembly 18 may include a bore 34 in at least one receiving portion 22 of the steering knuckle with a bushing 36 mounted therein. A corresponding kingpin 14 interface segment 26 is journaled within the bushing 36. The steering knuckle assembly 18 may additionally include an end seal 38 between the corresponding kingpin 14 interface segment 26 and receiving portion 22 in the steering knuckle assembly 18. The steering knuckle assembly 18 may additionally include at least one inner seal 40 between the corresponding kingpin 14 interface segment 26 and bushing 36. The inner seal provides additional protection and reduces the amount of debris entering the interface between the interface segment 26 and the receiving portion 22 of the steering knuckle assembly 18. According to one embodiment, the steer-axle assembly 10 is provided to include a sealant compressible shim 12 between the axle segment 20 and steering knuckle assembly 18, an inner seal 40 and an end seal 38 which combine to seal the interface between the kingpin 14 interface segment 26 and the receiving portion 22 of the steering knuckle.

FIG. 2 and FIG. 3 illustrate an embodiment of the sealant compressible shim 12. According to one embodiment, the first 28 and the second 30 substantially rigid shim layers are formed from a metal material. The substantially rigid shim layer may be formed from steel such as from plain carbon steel. According to one embodiment, the substantially rigid shim layers are each formed from hard temper SAE grade steel 1008. According to one embodiment, the substantially rigid shim layers are each formed from hard temper SAE grade steel 1010.

According to one embodiment, the compressible shim layer 32 is formed from a compressible elastomeric material. The compressible shim layer 32 may be sponge rubber, neoprene, or a neoprene blend. According to one embodiment, the compressible shim is formed from neoprene sponge identified as ASTM D-1056-85 grade 2C1. According to one embodiment, the compressible shim layer 32 is formed from a Nitrile type rubber material. According to one embodiment, the compressible shim layer 32 is formed from a Nitrile type of material identified as BUNA N having a durometer of 80.

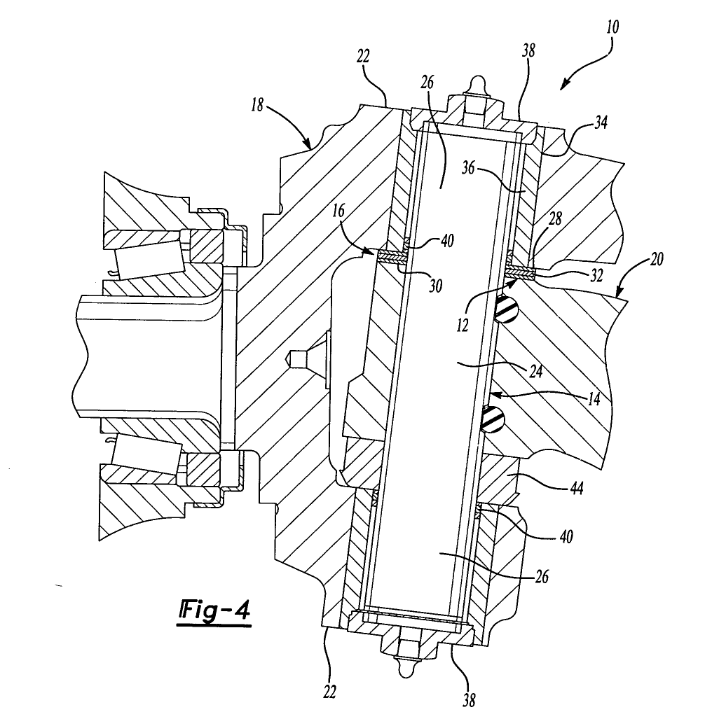

FIG. 4 illustrates an embodiment in which the steer-axle assembly 10 further includes a mounting means 42 for rotatably mounting the steering knuckle assembly 18 relative to the axle 20. The mounting means 42 may include at least one bearing 44 assembled in known manner surrounding the kingpin 14 body segment 24 between the axle 20 and the steering knuckle assembly 18. According to one embodiment, the bearing 44 is a thrust type bearing.

According to one embodiment, the steer-axle assembly 10 for sealing a gap 16 between an axle segment 20 and a steering knuckle assembly 18 includes an axle segment 20 having an outer end, a steering knuckle assembly 18 rotably coupled to the outer end and having an upper receiving portion 22 and a lower receiving portion 22, a kingpin 14 having a body segment 24 fixedly coupled to the axle segment 20, and an upper interface segment 26 received within the corresponding upper receiving portion 21, and a lower interface segment 26 received within the corresponding lower receiving portion 22 of the steering knuckle assembly 18. A sealant compressible shim 12 surrounds the kingpin 14 adjacent the upper interface segment 26 of the kingpin 14 and fills a gap 16 between the axle segment 20 and steering knuckle assembly 18 around the kingpin 14. The sealant compressible shim 12 has a first substantially rigid shim 28 layer disposed about the body segment 24 in contact with the upper receiving portion 22 of the steering knuckle assembly 18, a second substantially rigid shim 30 layer disposed about the body segment 24 in contact with the axle segment 20, and at least one compressible shim layer 32 between the first and second substantially rigid shim 30 layers. The steer-axle assembly 10 may further include a mounting means 42 for rotatably mounting the steering knuckle assembly 18 relative to the axle segment 20. The mounting means 42 may include a bearing 44 assembled in known manner adjacent the lower interface segment 26 of the kingpin 14. The bearing 44 surrounds the body segment 24 and fills the gap between the axle segment 20 and the lower receiving portion 22 of the steering knuckle assembly 18. According to one embodiment, the bearing 44 is a thrust type bearing.

According to one embodiment, the sealant compressible shim is at least partially located within an outer bore of the steering knuckle assembly 18 and the adjacent interface segment 24 is located within an inner bore of the steering knuckle assembly 18.

The sealant compressible shim 12 of the present invention results in reduced wear of the interface between the interface segment 24 and steering knuckle assembly 18 due to entry of foreign matter through a gap 16 between the axle segment 20 and steering knuckle assembly 18.

While the invention has been particularly shown and described with reference to the preferred embodiments thereof, it is well understood by those skilled in the art that various changes and modification can be made in the invention without departing from the spirit and scope of the invention.

1. A steer-axle assembly, comprising:
an axle segment having an end;
a steering knuckle assembly rotatably mounted to the end of the axle segment, the steering knuckle assembly having at least one receiving portion;
a kingpin having a body segment and an interface segment, the body segment fixedly coupled to the axle segment and the interface segment extending through a corresponding receiving portion of the steering knuckle assembly; and
at least one sealant compressible shim adjacent the interface segment, filling a gap between the axle segment and steering knuckle assembly around the kingpin, the sealant compressible shim having:
a first substantially rigid shim layer disposed about the kingpin body segment in contact with the steering knuckle assembly;
a second substantially rigid shim layer disposed about the kingpin body segment in contact with the axle segment; and
at least one compressible shim layer between the first and second substantially rigid shim layers.

2. The steer-axle assembly of claim 1 wherein the receiving portion of the steering knuckle assembly includes a bore having a bushing mounted therein and the kingpin interface segment is received within the bushing.

3. The steer-axle assembly of claim 1 further including an end seal between the kingpin interface segment and the corresponding receiving portion in the steering knuckle assembly.

4. The steer-axle assembly of claim 2 further comprising at least one inner seal between the kingpin interface segment and the bushing.

5. The steer-axle assembly of claim 4 further including an end seal between the kingpin interface segment and the corresponding receiving portion of the steering knuckle assembly.

6. The steer-axle assembly of claim 1 wherein the first and the second substantially rigid shim layers are formed from a metal material.

7. The steer-axle assembly of claim 6 wherein the metal material is selected from the group consisting of: steel, plain carbon steel, hard temper SAE grade steel 1008, and hard temper SAE grade steel 1010.

8. The steer-axle assembly of claim 1 wherein the compressible shim layer is formed of a compressible elastomeric material.

9. The steer-axle assembly of claim 8 wherein the compressible elastomeric material is a material selected from the group consisting of: sponge rubber, neoprene, neoprene blend, neoprene sponge ASTM D-1056-85 grade 2C1, nitrile rubber, nitrile BUNA N.

10. The steer-axle assembly of claim 1, further comprising:
a mounting means for rotatably mounting the steering knuckle assembly relative to the axle segment.

11. The steer-axle assembly of claim 10 wherein the mounting means includes at least one bearing surrounding the kingpin between the axle segment and the steering knuckle assembly, the bearing having a first portion fixedly coupled to the axle segment, and a second portion fixedly coupled to the steering knuckle assembly.

12. A steer-axle assembly, comprising:
an axle segment having an outer end;
a steering knuckle assembly rotatably coupled to the outer end and having an upper receiving portion and a lower receiving portion;
a kingpin having a central body segment fixedly coupled to the axle segment, and an upper interface segment received within the upper receiving portion and a lower interface segment received within the lower receiving portion of the steering knuckle assembly; and
a sealant compressible shim adjacent the upper interface segment of the kingpin, filling a gap between the axle segment and the steering knuckle assembly around the kingpin, the sealant compressible shim having:
a first substantially rigid shim layer disposed about the kingpin body segment in contact with the steering knuckle assembly;
a second substantially rigid shim layer disposed about the kingpin body segment in contact with the axle segment; and
at least one compressible shim layer between the first and second substantially rigid shim layers.

13. The steer-axle assembly of claim 12 further comprising:
a mounting means for rotatably mounting the steering knuckle assembly relative to the axle segment.

14. The steer-axle assembly of claim 13 wherein the mounting means includes a bearing adjacent the lower interface segment, the bearing surrounding the kingpin between the axle segment and the steering knuckle assembly, the bearing having a first portion fixedly coupled to the axle segment, and a second portion fixedly coupled to the steering knuckle assembly.

15. A sealant compressible shim for filling a gap between a steering knuckle assembly and an axle segment, comprising:
a first substantially rigid shim layer;
a second substantially rigid shim layer; and
at least one compressible shim layer between the first and second substantially rigid shim layers; and
wherein the first substantially rigid shim layer, second substantially rigid shim layer, and the at least one compressible shim layer are adapted to be mounted about a kingpin body segment and together fill a gap between the steering knuckle assembly and the axle segment.

16. The sealant compressible shim of claim 15 wherein the first and the second substantially rigid shim layers are formed from a metal material.

17. The sealant compressible shim of claim 16 wherein the metal material is selected from the group consisting of: steel, plain carbon steel, hard temper SAE grade steel 1008, and hard temper SAE grade steel 1010.

18. The sealant compressible shim of claim 15 wherein the compressible shim layer is formed of a compressible elastomeric material.

19. The sealant compressible shim of claim 18 wherein the compressible elastomeric material is a material selected from the group consisting of: sponge rubber, neoprene, neoprene blend, neoprene sponge ASTM D-1056-85 grade 2C1, nitrile rubber, nitrile BUNA N.
